(19) United States
(12) Patent Application Publication
(10) Pub. No.: US 2014/0287632 A1
(43) Pub. Date: Sep. 25, 2014

(54) SCREW WITH HOLE AND METHOD

(71) Applicant: Jeremy Brown, Granada Hills, CA (US)

(72) Inventor: Jeremy Brown, Granada Hills, CA (US)

(21) Appl. No.: 13/849,242

(22) Filed: Mar. 22, 2013

(51) Int. Cl. H01R 13/42; H01R 43/033

(52) U.S. Cl. CPC H01R 13/42; H01R 43/033
USPC 439/808; 29/854

(57) ABSTRACT

A device and method for using a screw to connect wires to an electrical component, without the need for additional tools, to manipulate the wire around the screw. The device is a screw with a body, head, and hole perpendicular to the rotational axis of the body and adjacent to the screw head. A wire is connected to the electrical component by inserting the end of an exposed wire into the hole through the screw and then tightening the screw, causing the exposed wire to loop around the screw and become secured between the screw and electrical component in a secure manner. For larger holes, a section with a larger diameter than the screw body may be disposed between the screw body and screw head.

### CROSS-REFERENCE TO RELATED APPLICATION

Not Applicable

### FEDERALLY SPONSORED RESEARCH

Not Applicable

### SEQUENCE LISTING OR PROGRAM

Not Applicable

### BACKGROUND

Currently, many electrical components such as light switches and electrical outlets are connected to wires using a “side-wire” method whereby each wire to be connected to the electrical component is stripped of a small section of its protective covering and the small section of exposed wire is wrapped around a threaded screw, the screw is then tightened down, causing the exposed wire to be secured between the electrical component's housing and the screw head. This connection is necessary to ensure a steady current of electricity, for example, between a power source and a light switch.

A secure and tight connection between each wire and the electrical component is critical. If the wire connection becomes loose, the electrical component will fail to operate and in some cases, an arch of electricity passing between the wire and housing may lead to an electrical fire.

To assure that the wire is secure and tight using the current side-wire technique, the wire must be looped around the threaded portion of the screw in the proper direction (i.e. clockwise). If the wire is wrapped around the wrong direction (i.e., counter-clockwise manner), the wire loop may loosen upon tightening of the screw. In time, the wire may become displaced, causing a loss of electrical connection, resulting in inconvenience and dangerous safety hazard for persons relying upon the electricity.

Multiple tools are needed to wrap the exposed wire around and tighten the screw to connect wires with the current side-wire technique. Moreover, the installation often requires the handling of wires, multiple tools, and the electrical component in a small workspace. Improperly connected wires also occur due to lack of experience or caution by the person conducting the installation. For the foregoing reasons, there is a need for an electrical component connection screw and method of installation that can be used to connect wires to an electrical component in a secure, simple to use and reliable manner.

The solution is found in the present invention which comprises a connection screw with a hole perpendicular to the rotational axis of the screw, into which a wire may pass through. When the screw is tightened with a screwdriver, the wire loops around the screw, in addition to passing through the screw, making it more difficult for the wire to loosen its connection to the screw.

### SUMMARY

The present invention is directed to a device and method for connecting wires to an electrical component in a secure, simple to use and reliable manner, with out the need for an additional tool. The device comprises an electrical component connection screw with a hole perpendicular to the rotational axis of the screw to allow a wire to be passed through the screw prior to final tightening.

The traditional side-wire technique does not prevent an installer from looping the wire around the screw incorrectly, and requires the installer to remember the proper direction, which can be problematic especially for novices. The present invention prevents incorrect installation because with the insertion of the wire through the screw, in addition to wrapping around the screw, it becomes more difficult for the wire to become loose regardless of the direction of rotation (although standard wires normally rotate in only the clockwise direction). Also, the present invention only requires a screwdriver to make the connection between the wire and screw, while the traditional screw and side-wire technique requires the use of pliers and a screwdriver to bend and wrap the wire around, and tighten, the screw. With the present invention, once the wire is passed through the hole and the screw tightened, the wire is forced to wrap around the screw in such a manner that it becomes difficult for the wire to become loose, thereby creating a secure and reliable connection between the wire and the electrical component.

### DRAWINGS

FIG. 1A illustrates a perspective view of an embodiment of the present invention of a screw with hole and method for connecting wires to an electrical component.

FIG. 1B illustrates a close-up view of the screw with hole and wire connected to an electrical component shown in FIG. 1A.

FIG. 2 illustrates a perspective view of the screw with a hole, threaded body and head.

FIG. 3 illustrates a perspective view of the screw with a section of exposed wire inserted through the hole.

FIG. 4A illustrates a side view of an electrical component with screws installed before wires are connected.

FIG. 4B illustrates a bottom view of an electrical component with screws featuring holes installed prior to connecting the wires.

FIG. 5 illustrates a side view of an electrical component with a wire inserted through hole in the screw prior to final tightening of the screw.

FIG. 6 illustrates an alternate embodiment of the screw providing for a larger hole and increased contact area between the screw and wire.

### DESCRIPTION

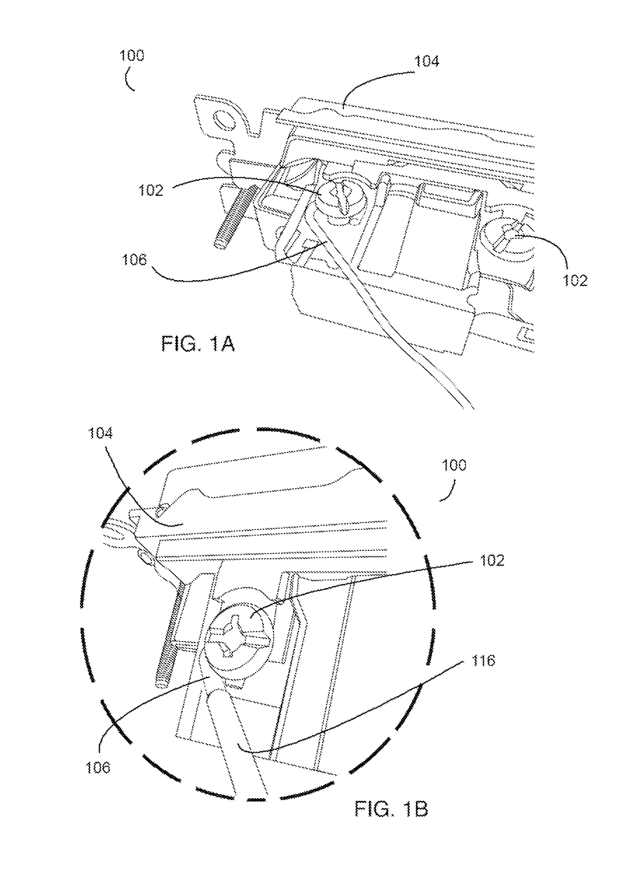

FIGS. 1-5 illustrates an embodiment of the present invention, a device and method for connecting wires to an electrical component 100. The invention comprises an electrical component 104 with screw 102 and wire 106. The electrical component 104 may be of various types typically used in the field of wired electrical hardware.

As illustrated in FIGS. 1A, 4A, and 5, electrical components 104 are devices such as light switches and electrical outlets connected to power by wires. The typical electrical component 104 may function as a means of controlling power to other devices as in the case of a light switch or sensor, or as means of transmitting power as in the case of an electrical outlet. Connection between the electrical component 104 and wires 106 is done using a screw 102 of the present invention for each wire 106 as best illustrated in FIGS. 1A-1B. It should be noted that the present invention may be applied for the connection of wires to components in various settings, including residential and commercial applications.

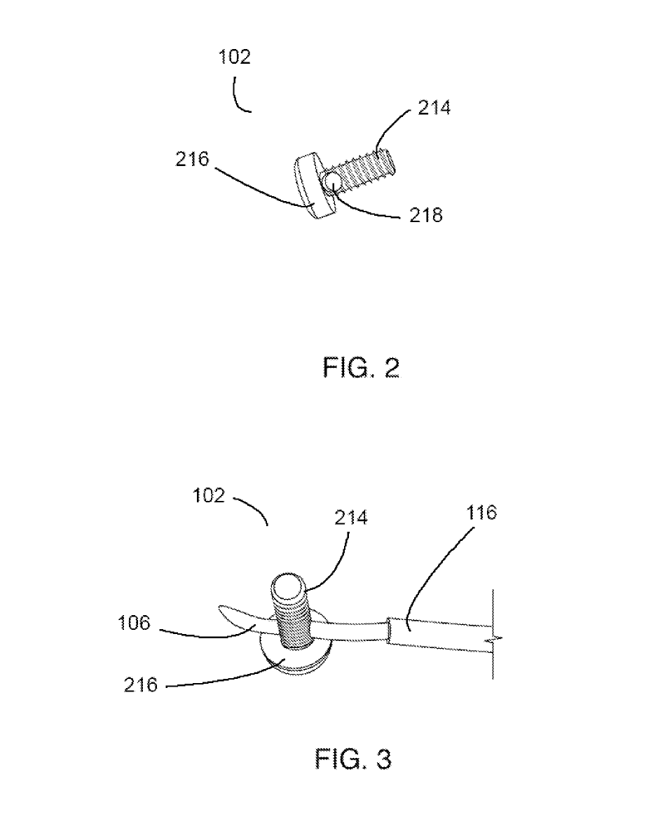

FIGS. 2-3 illustrate the screw 102 of the present invention. The screw 102 is an elongated cylinder with a threaded body 214 terminating in a head 216 with a larger diameter than the threaded body 214. The head 216 may have an axial indentation to mate with a tool for turning the screw 102 such as a screwdriver or socket as shown in FIG. 1B, or the head 216 may comprise a wingnut for hand-tightening. A hole 218 is located perpendicular to the rotational axis of the threaded body 214 and adjacent to the screw head 216. The hole 218 diameter should be suitable to allow a wire 106 of the particular gauge size being used to pass through the hole 218. The screw 102 with hole 218 may be composed of metal or an alternative material capable of conducting electricity. Manufacturing of the screw 102 can be done using conventional methods such as casting of the screw 102 with a hole 218, machining, or forging.

FIG. 6 illustrates an alternative embodiment of the screw 102 of the present invention. The section 220 of the screw 102 adjacent to the screw head 216 comprises a diameter larger than the threaded body 214 of the screw 102 but smaller than the diameter of the screw head 216. This larger diameter section 220 allows a larger hole 218 to be made through the rotational axis of the screw 102, and more contact area between the screw 102 and wire 106, while maintaining the material strength of the screw 102.

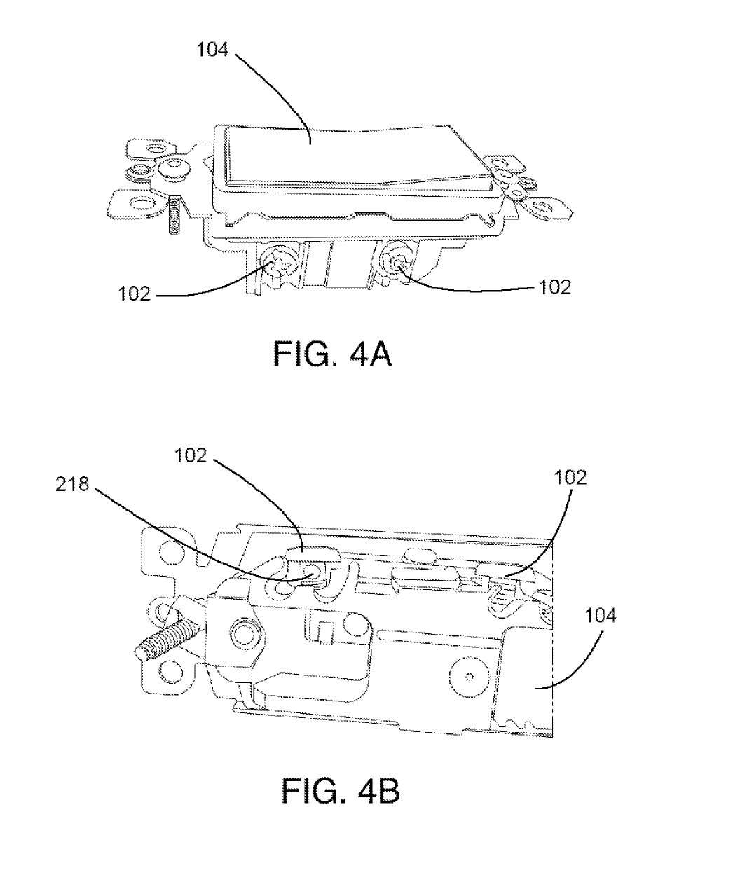

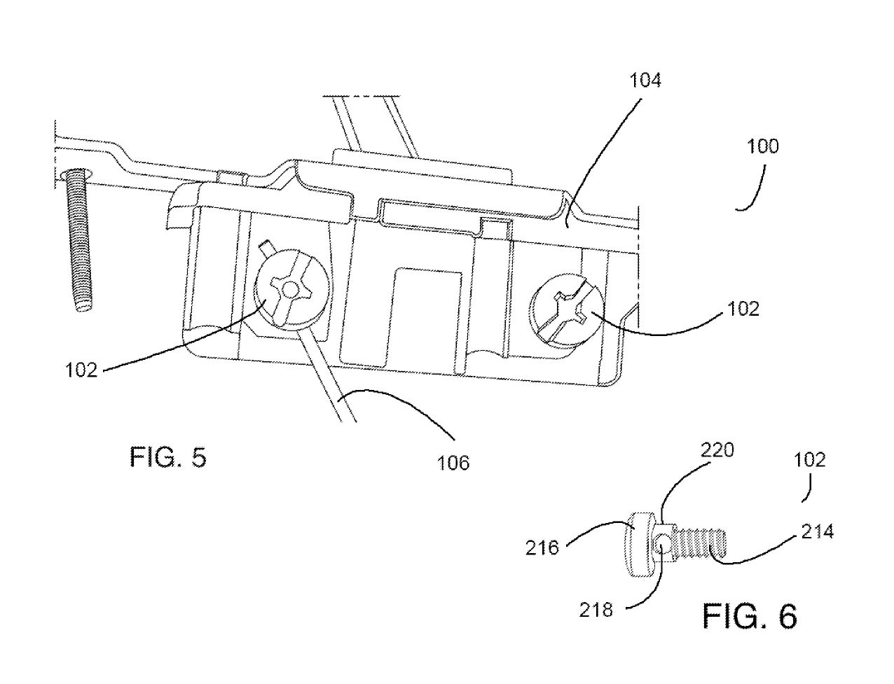

The screw with hole 100 functions to secure the wire 106 to the electrical component 104 by passing a wire 106, which has been stripped of its protective covering 116, into the hole 218 through the threaded screw 102 just before the screw is tightened down. To use the screw with hole and method 100, the screw 102 is advanced or tightened into the electrical component 104 so that only the hole 218 in the screw 102 is exposed, as best illustrated in FIG. 4B. Next, a small section of protective covering 116 is stripped from the wire 106. The length of exposed wire 106 should be long enough so that exposed wire 106 is in contact with the screw 102 and electrical component housing 104 after tightening the screw 102 (FIG. 1B). The exposed wire 106 is then inserted through the hole 218 of the screw 102 (FIG. 5). Finally, the screw 102 is tightened with the exposed wire 106 inserted into the hole 218, resulting in the wire 106 looped around the circumference of the threaded body 214 of screw 102 in a clockwise manner. As a result, the wire 106 is bound between the screw head 216 and electrical component housing 104, and secured by the binding force of the tightened screw 102, screw head 216, and rigidity of the wire 106.

All features disclosed in this specification, including any accompanying claim, abstract, and drawings, may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C. §112,paragraph 6. In particular, the use of “step of” in the claims herein is not intended to invoke the provisions of 35 U.S.C. §112, paragraph 6.

Although preferred embodiments of the present invention have been shown and described, various modifications and substitutions may be made thereto without departing from the spirit and scope of the invention. Accordingly, it is to be understood that the present invention has been described by way of illustration and not limitation.

What is claimed is:

1. A solid state cup device that assists a coil over arrangement of an air suspension system for at least one motor vehicle wheel, the device comprising: at least one outer cup having a plurality of o-rings placed on the coil over arrangement; and at least one inner cup having a plurality of smaller o-rings, said at least one inner cup placed on top of at least one spring; whereby with air injected into the at least one outer cup, the at least one inner cup may press down the at least one spring to provide tension on the at least one spring resulting in a smoother lift and lowering of the at least one motor vehicle wheel:

2. The solid state cup device of claim 1, wherein the at least one outer cup includes at least one c-ring to prevent the at least one inner cup from sliding out of the at least one outer cup.

3. The solid state cup device of claim 1, wherein the at least one outer cup may be adapted for receiving at least one air injecting means.

4. The solid state cup device of claim 1, wherein the plurality of o-rings are arranged in an inner diameter of the at least one outer cup for providing protection from an air leak.

5. The solid state cup device of claim 1, wherein the at least one coil over arrangement is a strut-spring arrangement.

6. The solid state cup device of claim 1, wherein the at least one solid state cup device is made from aluminum, titanium, iron, steel, or wood.

7. The solid state cup device of claim 1, wherein the at least one cup device may be made from an aluminum alloy.

8. The solid state cup device of claim 7, wherein the alloy is a 6061 aluminum material.

9. The solid state cup device of claim 1, wherein the at least one solid state cup device is air leak protected by way of a dual-quad air leak protection mechanism.

10. The solid state cup device of claim 1, wherein the cup device is adapted to move from a raised position to a lowered position, and vice versa.

11. A method of using a solid state cup device to assists a coil-over arrangement of an air suspension system of a motor vehicle, the method comprises: Activating at least one switch 160 to move air from an air compressor into the direction of the solid state cup, the air first entering an inlet to a reserve tank and then existing the reserve tank, then entering the solid state cup through an opening which then forces an inner cup of the solid state cup in a downward direction, thereby raising suspension of the motor vehicle; and deactivating the at least one switch so that air is released from the solid state cup, thereby allowing the inner cup to rise and lower suspension of the motor vehicle.

12. A method of installing a solid state cup device to a motor vehicle, comprising the steps of: Removing the original OEM coil over suspension; Assemble the solid state cup device to the OEM coil over suspension and reinstalling the OEM coil over suspension; and Installing ¼ tubing lines to the solid state cup and routing the tubing lines through the inside of the motor vehicle to a valve command switch, air compressor, and air reserve tank, wherein the air compressor and air reserve tank are installed in the trunk of the motor vehicle.
